(19) United States
(12) Patent Application Publication
(10) Pub. No.: US 2010/0316908 A1
(43) Pub. Date: Dec. 16, 2010

(54) BATTERY

(75) Inventors: Kentaro Yoshimura, Fukushima (JP); Masayuki Ihara, Fukushima (JP); Tadahiko Kubota, Kanagawa (JP)

Correspondence Address: K&L Gates LLP, P. O. BOX 1135, CHICAGO, IL, 60690, US

(73) Assignee: SONY CORPORATION, Tokyo (JP)

(21) Appl. No.: 12/792,260

(22) Filed: Jun. 2, 2010

(30) Foreign Application Priority Data
Jun. 11, 2009 (JP) P2009-140378

(51) Int. Cl. H01M 10/26

(52) U.S. Cl. 429/207

(57) ABSTRACT

A nonaqueous electrolyte secondary battery includes: a positive electrode; a negative electrode; a nonaqueous electrolyte containing an electrolyte salt; and a separator, wherein in the electrolyte salt, a molar fraction x of at least one member selected among electrolyte salts represented by the following formulae (1) and (2) occupying in the whole electrolyte salt satisfies a relationship of (0.5<x≦1)

LiPFₐA_{c} (1)

LiBF_{b}B′_{d} (2)
wherein a represents an integer of from 0 to 5; b represents an integer of from 0 to 3; each of A and B′ independently represents CₙF₂ₙ₊₁; n represents an integer of from 1 to 6; c represents an integer of 1 or more and satisfies a relationship of (a+c=6); and d represents a an integer of 1 or more and satisfies a relationship of (b+d=4).

### CROSS REFERENCES TO RELATED APPLICATIONS

The present application claims priority to Japanese Priority Patent Application JP 2009-140378 filed in the Japan Patent Office on Jun. 11, 2009, the entire contents of which is hereby incorporated by reference.

### BACKGROUND

The present application relates to a battery using a positive electrode active material containing lithium (Li) and a nonaqueous electrolyte using the same.

Owing to the remarkable development of a portable electronic technology in recent years, electronic appliances such as mobile phones and laptop personal computers have started to be recognized as a basic technology supporting a high-level information society. Also, research and development on high functionalization of such an electronic appliance are energetically advanced, and the consumed electric power of such an electronic appliance increases steadily in proportion thereto. On the contrary, such an electronic appliance is to be driven over a long period of time, and realization of a high energy density of a secondary battery as a drive power source has been inevitably desired. Also, in view of consideration of the environment, the prolongation of a cycle life has been desired.

From the viewpoints of occupied volume and mass of a battery to be built in an electronic appliance, it is desirable that the energy density of the battery is as high as possible. At present, in view of the fact that a lithium ion secondary battery has an excellent energy density, the lithium ion secondary battery is now built in almost all of appliances.

Usually, the lithium ion secondary battery uses lithium cobaltate for a positive electrode and a carbon material for a negative electrode, respectively and is used at an operating voltage in the range of from 4.2 V to 2.5 V. The fact that in a single cell, a terminal voltage can be increased to 4.2 V largely relies upon excellent electrochemical stability of a nonaqueous electrolyte material or a separator or the like.

For the purposes of realizing higher functionalization and enlarging applications on such a lithium ion secondary battery, a number of investigations are being advanced. As one of them, for example, it is studied to contrive to realize a high capacity of a lithium ion secondary battery by enhancing an energy density of a positive electrode active material including lithium cobaltate with a method of increasing a charge voltage or the like.

However, in the case where charge and discharge are repeated at a high capacity, in particular, in a high-temperature region, a nonaqueous electrolyte coming into physical contact with a positive electrode is oxidatively decomposed, and a gas is generated to cause defectives such as blister, rupture, liquid leakage and the like of the battery. Also, a transition metal contained in the active material elutes into the nonaqueous electrolyte and is deposited on a negative electrode, thereby causing a fine internal short circuit; and therefore, there were caused problems such that the safety is remarkably impaired, deterioration of the capacity occurs, and a battery life is shortened.

Then, a method in which a positive electrode active material is modified, thereby enhancing its chemical stability, suppressing elution of a transition metal into a nonaqueous electrolyte or the like and improving battery characteristics is investigated. Alternatively, a method in which a compound having a special function imparted thereto is added in a nonaqueous electrolyte, thereby forming a minute coating film on either one of a positive electrode or a negative electrode or both of them and preventing deterioration of a battery capacity especially at a high temperature is widely adopted.

For example, Japanese Patent No. 3172388 discloses a method in which a metal oxide is coated on the surface of a positive electrode, thereby improving cycle characteristics. Also, JP-A-2000-195517 discloses a method in which a metal oxide coating is formed on the surface of a positive electrode active material, thereby suppressing elution of a transition metal into a nonaqueous electrolyte and enhancing a battery life.

JP-A-2002-270181 reports that when an electrode contains a phthalimide compound, and the compound which has been dissolved in a nonaqueous electrolyte is adsorbed onto a positive electrode or a negative electrode, an effect for suppressing elution of a transition metal is obtained in the positive electrode, whereas deposition of the eluted metal is prevented in the negative electrode, whereby battery characteristics at a high temperature are improved. Also, JP-A-2005-72003 reports that the addition of a nitrile derivative improves battery characteristics. At the same time, JP-A-2005-72003 reports that in the case of using a mixed solvent such as a mixture of a cyclic or chain ester and a lactone, battery blister at the time of high-temperature storage can be suppressed.

Besides the foregoing technologies, JP-A-2002-138095, JP-A-2002-356491 and JP-A-2002-280066 propose a chemically stable lithium fluoroalkyl phosphate as an electrolyte salt capable of being a replacement for lithium hexafluorophosphate which has hitherto been used in lithium batteries and report the use for a variety of electrochemical devices and possibility of improving characteristics.

However, in the case where the transition metal oxide contained in the positive electrode active material is merely stabilized as in Japanese Patent No. 3172388 and JP-A-2000-195517, the transition metal which has once eluted from the positive electrode entirely accumulates onto a separator or deposits on the negative electrode, and though it may be possible to contrive to improve deterioration of the capacity, the effect is still insufficient. Also, since the surface of the positive electrode in a highly oxidized state in the charged state sufficiently maintains the activity, there was involved such a problem that the generation of a gas due to decomposition of the nonaqueous electrolyte or the separator coming into physical contact with the surface of the positive electrode is large.

Also, in the case where a specified compound is added in the nonaqueous electrolyte as in JP-A-2002-270181 and JP-A-2005-72003, in particular, under a high voltage at which an open circuit voltage is higher than 4.2 V, there is often the case where the effect is not obtained because of the fact that its action reversely works as a trigger, whereby the transition metal vigorously elutes from the position electrode. Also, a number of nitrogen-containing compounds are reductively decomposed on the side of the negative electrode, leading to cycle deterioration, and therefore, such is not preferable.

Also, though with respect to the nonaqueous electrolytes proposed in JP-A-2002-138095 and JP-A-2002-356491, a possibility of the use is mentioned, there is involved a defect that they are inferior in conductivity to practically used electrolytes; and there is no example in which such a nonaqueous electrolyte is actually applied to an electrochemical device, and its effect is not elucidated yet. JP-A-2002-280066 reports a specific use example of LiPF₃(C₂F₅)₃ as the electrolyte salt in a secondary battery and elucidates a possibility of its application; however, remarkably excellent effects are not found yet, and it is difficult to expect effects to be brought according to an embodiment.

In the light of the above, in many cases, the method of enhancing stability of the positive electrode active material in the nonaqueous electrolyte upon being modified, or the method of preventing deterioration of the battery by the function of a compound added in the nonaqueous electrolyte, is still insufficient in realizing a secondary battery having a high capacity and an excellent high-temperature characteristic. Also, with respect to replacement technologies for the nonaqueous electrolyte, almost all of effects on an application to batteries have not been elucidated yet.

Also, in the case of combining the foregoing technologies, though a higher effect could be expected from the viewpoint of improving battery characteristics, as a result of actual investigations, there was often seen the case where the positive electrode is reversely eroded, or an impedance in the inside of the battery increases, thereby impairing the battery characteristics. In particular, in batteries which are used under a high-temperature condition or in which the voltage after charge is set to be 4.25 V or more, adverse influences were remarkable.

### SUMMARY

It is desirable to provide a battery which is able to achieve a high energy density and which is excellent in a high-temperature characteristic and a cycle characteristic.

According to an embodiment, there is provided a nonaqueous electrolyte secondary battery including a positive electrode, a negative electrode containing an electrolyte salt, a nonaqueous electrolyte and a separator, wherein

In the electrolyte salt, a molar fraction x of at least one member selected among electrolyte salts represented by the following formulae (1) and (2) occupying in the whole electrolyte salt satisfies a relationship of (0.5<x≦1):

LiPFₐA_{c} (1)

LiBF_{b}B′_{d} (2)

wherein

a represents an integer of from 0 to 5; b represents an integer of from 0 to 3; each of A and B′ independently represents CₙF₂ₙ₊₁; n represents an integer of from 1 to 6; c represents an integer of 1 or more and satisfies a relationship of (a+c=6); and d represents a an integer of 1 or more and satisfies a relationship of (b+d=4).

According to another embodiment, there is provided a nonaqueous electrolyte, wherein a molar fraction x of at least one member selected among electrolyte salts represented by the foregoing formulae (1) and (2) occupying in the whole electrolyte salt satisfies a relationship of (0.5<x≦1).

In the battery according to the embodiment, the electrolyte salt is one obtained by dissolving at least one member selected among the lithium salts represented by the foregoing formulae (1) and (2) in a nonaqueous solvent such that its molar fraction x satisfies a relationship of (0.5<x≦1).

In the embodiment according to the present application, the nonaqueous electrolyte means a medium containing at least a nonaqueous solvent and/or an electrolyte salt and capable of further containing a polymer compound, a variety of additives and the like, if desired and also having conductivity of ions intervening between a positive electrode and a negative electrode.

In the battery according to the embodiment, even in the case where it is used under a high-temperature condition, or even in the case where the voltage after charge reaches 4.25 V or more, corrosion of the positive electrode is suppressed, and an increase of an impedance in the inside of the battery is not observed. Accordingly, it is possible to realize a battery which is able to attain a high energy density and which is excellent in a high-temperature characteristic and a cycle characteristic.

Additional features and advantages are described herein, and will be apparent from the following Detailed Description and the figures.

### BRIEF DESCRIPTION OF THE FIGURES

FIG. 1 is a sectional view showing a configuration of a secondary battery according to a first embodiment.

FIG. 2 is a sectional view showing enlargedly a part of a wound electrode body in the secondary battery shown in FIG. 1.

FIG. 3 is an exploded perspective view showing a configuration of a secondary battery according to a second embodiment.

FIG. 4 is a schematic sectional view showing a configuration along a VIII-VIII line of a wound electrode body shown in FIG. 3.

### DETAILED DESCRIPTION

The present application is described below in greater detail with reference to the drawings according to an embodiment.

LiPFₐA_{c} represented by the formula (1) is described.

In the formula (1), a represents an integer of from 0 to 5, and preferably an integer of from 1 to 4; A represents CₙF₂ₙ₊₁; n represents an integer of from 1 to 6, and preferably an integer of from 1 to 4; and c represents an integer of 1 or more and satisfies a relationship of (a+c=6), and preferably an integer of from 2 to 5.

Specific examples of LiPFₐA_{c} represented by the formula (1) include LiPF₃(CF₃)₃, LiPF₃(C₂F₅)₃, LiPF₃(C₃F₇)₃, LiPF₃(C₄F₉)₃, LiPF₄(CF₃)₂, LiPF₄(C₂F₅)₂, LiPF₄(C₃F₇)₂ and LiPF₄(C₄F₉)₂ (wherein each of the hydrocarbon groups represented by C₃F₇ and C₄F₉ may be either linear or branched).

Though there is no report example for synthesis, other examples include lithium salts represented by general formulae of LiP(CₒF₂ₒ₊₁)₆, LiPF(CₒF₂ₒ₊₁)₅, LiPF₂(CₒF₂ₒ₊₁)₄ and LiPF₅(CₒF₂ₒ₊₁), and it may be conjectured that the same effects as in the embodiment according to the present application are obtainable. In the foregoing formulae, o represents an integer other than 0, and the hydrocarbon group represented by CₒF2ₒ₊₁ may be either linear or branched.

LiBF_{b}B′_{d} represented by the formula (2) is described.

In the formula (2), b represents an integer of from 0 to 3, and preferably an integer of from 1 to 3; B′ represents CₙF₂ₙ₊₁; n represents an integer of from 1 to 6, and preferably an integer of from 1 to 4; and d represents an integer of 1 or more and satisfies a relationship of (b+d=4), and preferably an integer of from 1 to 3.

Specific examples of LiBF_{b}B′_{d} represented by the formula (2) include LiBF₃(CF₃), LiBF₃(C₂F₅), LiBF₃(C₃F₇), LiBF₂(C₂F₅)₂ and LiB(CF₃)₄ (wherein the hydrocarbon group represented by C₃F₇ may be either linear or branched).

Though there is no report example for synthesis, other examples include lithium salts represented by a general formula of LiBF(CₒF₂ₒ₊₁)₃, and it may be conjectured that the same effects as in the embodiment according to the present application are obtainable. In the foregoing formula, o represents an integer other than 0, and the hydrocarbon group represented by CₒF₂ₒ₊₁ may be either linear or branched.

In the embodiment according to the present application, one or more lithium salts other than those represented by the formulae (1) and (2) may be further included. On that occasion, it is especially preferable to include at least one compound selected from a chain imide salt represented by the following formula (3) and a cyclic imide salt represented by the following formula (4). This is because not only an effect for suppressing corrosion of the positive electrode is held, but a good conductivity is obtainable, and excellent high-temperature characteristic and cycle characteristic are obtainable. Even in the case where a charge final voltage is increased to 4.25 V or more, these effects are kept, and therefore, a high energy density can be achieved.

The formula (3) is described.

LiN(CₑF₂ₑ₊₁SO₂)_{g}(C_{f}F_{2f+}1SO2)_{2-g} (3)

In the formula (3), each of e and f represents an integer of from 0 to 6, and preferably an integer of from 0 to 4, provided that each of the hydrocarbon groups represented by CₑF₂ₑ₊₁ and C_{f}F_{2f+1} may be either linear or branched; and g represents an integer of from 0 to 2.

The electrolyte salt represented by the formula (3) is a lithium slat having a counter anion of a chain imide structure, and specific examples thereof include lithium salts such as LiN(FSO₂)₂, LiN(CF₃SO₂)₂, LiN(C₂F₅SO₂)₂, LiN(C₃F₇SO₂)₂, LiN(C₄F₉SO₂)₂, LiN(CF₃SO₂)(C₂F₅SO₂), LiN(CF₃SO₂)(C₃F₇SO₂), LiN(CF₃SO₂)(C₄F₉SO₂), LiN(C₂F₅SO₂)(C₃F₇SO₂), LiN(C₂F₅SO₂)(C₄F₉SO₂) and LiN(C₃F₇SO₂)(C₄F₉SO₂).

The formula (4) is described. The compound represented by the formula (4) is a lithium salt having a counter anion of a cyclic imide structure.

### Formula (4)

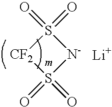

In the formula (4), m is 2 or 3. Accordingly, when m is 2, the compound has a structure represented by the following formula (4a).

### Formula (4a)

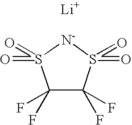

When m is 3, the compound has a structure represented by the following formula (4b).

### Formula (4b)

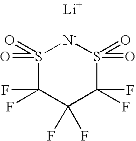

The nonaqueous electrolyte including the compound represented by the formula (1) and/or the compound represented by the formula (2) according to the embodiment may be used upon being mixed with other electrolyte salt in addition to the electrolyte salts represented by the foregoing formulae (3) and (4) or in place of these electrolyte salts. Examples of other electrolyte salt include LiPF₆, LiBF₄, LiAsF₆, LiClO₄, LiB(C₆H₅)₄, LiCH₃SO₃, LiCF₃SO₃, LiC(SO₂CF₃)₃, LiAlCl₄, LiSiF₆, LiCl, LiSiF₆, lithium difluoro[oxolato-O,O]borate, lithium bisoxolate borate, lithium monofluorophosphate, lithium difluorophosphate and LiBr. Such an electrolyte salt may be mixed singly and used, or plural kinds thereof may be mixed and used.

A total sum of the electrolyte salts contained in the nonaqueous electrolyte is preferably from 0.1 to 3.0 moles/kg, and more preferably from 0.5 to 2.0 moles/kg in the nonaqueous electrolyte. This is because a high ionic conductivity is obtainable.

Also, it is preferable that the nonaqueous electrolyte contains a cyano group-containing compound (also referred to as “cyano compound”) in an amount of from 0.01 to 10% by mass. The foregoing effects to be brought according to the embodiment are displayed within this range.

Examples of the cyano compound include acetonitrile, propionitrile, butyronitrile, valeronitrile, hexanenitrile, octanenitrile, undecanenitrile, decanenitrile, cyclohexanecarbonitrile, benzonitrile, phenylacetonitrile, malononitrile, succinonitrile, glutaronitrile, adiponitrile, sebaconitrile, sub eronitrile, 1,5-dicyanopentane, 1,6-dicyanohexane, 1,7-dicyanoheptane, 1,8-dicyanooctane, 1,9-dicyanononane, 1,10-dicyanodecane, 1,12-dicyanododecane, tetramethylsuccinonitrile, 2-methylglutaronitrile, 2,4-dimethylglutaronitrile, 2,2,4,4-tetramethylglutaronitrile, 1,4-dicyanopentane, 2,5-dimethyl-2,5-hexanedicarbonitrile, 2,6-dicyanoheptane, 2,7-dicyanooctane, 2,8-dicyanononane, 1,6-dicyanodecane, 1,2-dicaynobenzene, 1,3-dicyanobenzene, 1,4-dicyanobenzene, methoxyacetonitrile, 3-methoxypropionitrile, 1,3,5-cyclohexanetricarbonitrile, 1,2,3-propanetricarbonitrile and 7,7,8,8-tetracyanoquinodimethane. Such a cyano compound can be used singly or in combinations of two or more kinds thereof.

As the nonaqueous solvent which is used for the nonaqueous electrolyte, a cyclic carbonate which is a high-dielectric solvent having a dielectric constant of 30 or more, such as ethylene carbonate and propylene carbonate, can be used. The nonaqueous solvent may be used singly or in admixture of plural kinds thereof. It is especially preferable to include a halogen atom-containing cyclic carbonate derivative. This is because a favorable cycle characteristic can be obtained because a minute coating film is formed on the negative electrode, thereby suppressing reductive decomposition more than this.

Specific examples of the halogen atom-containing cyclic carbonate derivative include 4-fluoro-1,3-dioxolan-2-one (FEC), 4,5-difluoro-1,3-dioxolan-2-one (DFEC), 4-chloro-1,3-dioxolan-2-one and 4-trifluoromethyl-1,3-dioxolan-2-one.

In the nonaqueous solvent, in addition to the cyclic carbonate which is a high-dielectric solvent, it is preferable to use a mixture thereof with a chain carbonate which is a low-viscosity solvent having a viscosity of not more than 1 mPa·s, such as diethyl carbonate, dimethyl carbonate, ethyl methyl carbonate and methyl propyl carbonate. This is because high ionic conductivity is obtainable. The low-viscosity solvent may also be used singly or in admixture of plural kinds thereof.

Besides, butylene carbonate, vinylene carbonate, γ-butyrolactone, γ-valerolactone, 1,2-dimethoxyethane, tetrahydrofuran, 2-methyltetrahydrofuran, trimethyl orthoformate, triethyl orthoformate, tripropyl orthoformate, 1,3-dioxolane, 4-methyl-1,3-dioxolane, methyl acetate, methyl propionate, N,N-dimethylformamide, N-methylpyrrolidinone, N-methyloxazolidinone, N,N-dimethylimidazolidinone, nitromethane, nitroethane, sulfolane, fluorobenzene, dimethyl sulfoxide, trimethyl phosphate and the like are also useful as the nonaqueous solvent.

The embodiments according to the present application are hereunder described in detail by reference to the accompanying drawings.

### First Embodiment

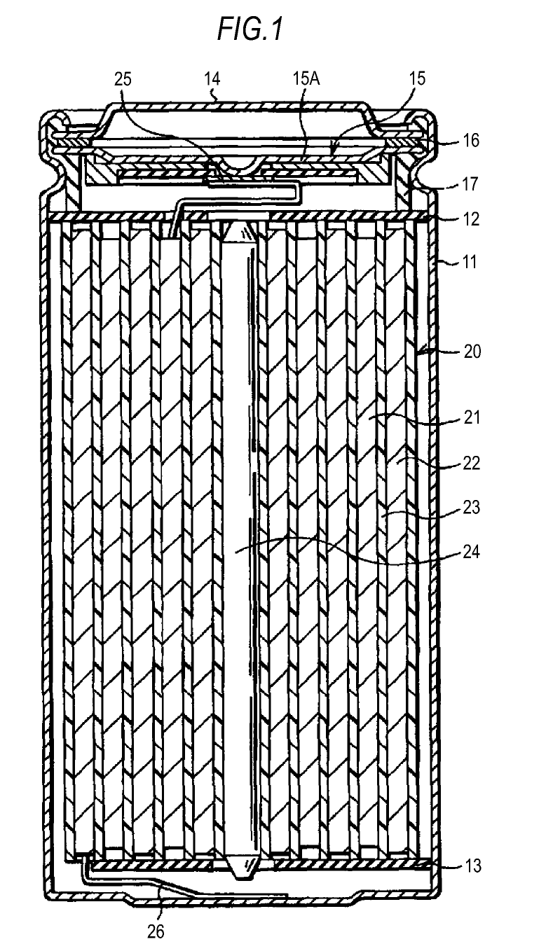

FIG. 1 shows a sectional structure of the secondary battery according to the present embodiment. This secondary battery is a so-called lithium ion secondary battery using lithium (Li) as an electrode reactant, in which the capacity of a negative electrode is expressed by a capacity component due to intercalation and deintercalation of lithium. This secondary battery is of a so-called cylindrical type and has a wound electrode body 20 having a pair of a strip-shaped positive electrode 21 and a strip-shaped negative electrode 22 wound via a separator 23 in the inside of a substantially hollow columnar battery can 11. The battery can 11 is constituted of, for example, nickel-plated iron, and one end thereof is closed, with the other end being opened. In the inside of the battery can 11, a pair of insulating plates 12 and 13 is respectively disposed vertical to the winding peripheral face so as to interpose the wound electrode body 20 therebetween.

In the open end of the battery can 11, a battery lid 14 is installed by caulking with a safety valve mechanism 15 and a positive temperature coefficient device (PTC device) 16 provided in the inside of this battery lid 14 via a gasket 17, and the inside of the battery can 11 is hermetically sealed. The battery lid 14 is constituted of, for example, the same material as that in the battery can 11. The safety valve mechanism 15 is electrically connected to the battery lid 14 via the positive temperature coefficient device 16. In this safety valve mechanism 15, when the internal pressure of the battery reaches a fixed value or more due to an internal short circuit or heating from the outside or the like, a disc plate 15A is reversed, whereby electrical connection between the battery lid 14 and the wound electrode body 20 is disconnected. When the temperature rises, the positive temperature coefficient device 16 controls the current by an increase of the resistance value, thereby preventing abnormal heat generation to be caused due to a large current. The gasket 17 is constituted of, for example, an insulating material, and asphalt is coated on the surface thereof.

For example, a center pin 24 is inserted on the center of the wound electrode body 20. In the wound electrode body 20, a positive electrode lead 25 made of aluminum or the like is connected to the positive electrode 21; and a negative electrode lead 26 made of nickel or the like is connected to the negative electrode 22. The positive electrode lead 25 is electrically connected to the battery lid 14 by means of welding with the safety valve mechanism 15; and the negative electrode lead 26 is electrically connected to the battery can 11 by means of welding.

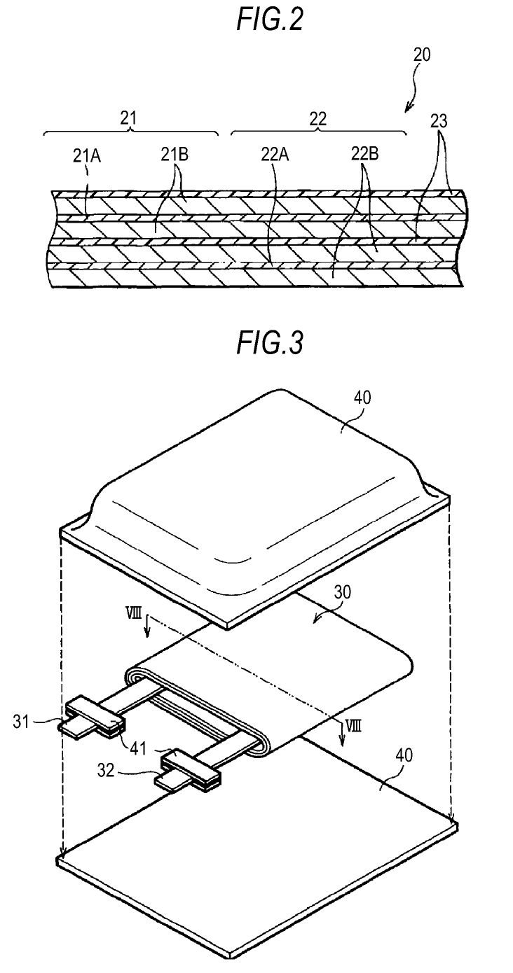

FIG. 2 shows enlargedly a part of the wound electrode body 20 shown in FIG. 1. The positive electrode 21 has, for example, a structure in which a positive electrode active material layer 21B is provided on the both surfaces of a positive electrode collector 21A having a pair of surfaces opposing to each other. While illustration is omitted, the positive electrode active material layer 21B may be provided on only one surface of the positive electrode collector 21A. The positive electrode collector 21A is constituted of a metal foil, for example, an aluminum foil, etc. The positive electrode active material layer 21B is constituted such that it contains, as a positive electrode active material, one or two or more kinds of positive electrode materials capable of intercalating and deintercalating lithium and further contains a conductive agent such as graphite and a binder such as polyvinylidene fluoride, if desired.

Examples of the positive electrode material capable of intercalating and deintercalating lithium include a lithium complex oxide having a structure of a layered rock salt type expressed by an average composition represented by the _{following} formula (5). This is because such a lithium complex oxide is able to enhance the energy density. Specific examples of such a lithium complex oxide include Liₕ₁CoO₂ (h1≅1) and Liₕ₂Niₕ₃Co₍₁₋ₕ₃₎O₂ (h2≅1 and 0<h3≦0.5).

Liᵢ₁Co₍₁₋ᵢ₂₎M1ᵢ₂O₍₂₋ᵢ₃₎Fᵢ₄ (5)

In the formula (5), M1 represents at least one member selected from the group consisting of nickel, manganese, magnesium, aluminum, boron, titanium, vanadium, chromium, iron, copper, zinc, molybdenum, tin, calcium, strontium and tungsten; and i1, i2, i3 and i4 represent values falling within the ranges of 0.8≦i1≦1.2, 0≦i2<0.5, −0.1≦i3≦0.2 and 0≦i4≦0.1, respectively. The composition of lithium varies depending upon the state of charge and discharge, and the value of i1 represents a value in a completely discharged state.

In addition to these positive electrode materials, the positive electrode material capable of intercalating and deintercalating lithium may be further mixed with other positive electrode material. Examples of such other positive electrode material include other lithium oxides, lithium sulfides and other lithium-containing intercalation compounds (examples thereof include a lithium complex oxide having a structure of a layered rock salt type expressed by an average composition represented by the following formula (6) or (7); a lithium complex oxide having a structure of a spinel type expressed by an average composition represented by the following formula (8); and a lithium complex phosphate having a structure of an olivine type represented by the following formula (9)).

LiⱼᵢMn₍₁₋ⱼ₂₋ⱼ₃₎Niⱼ₂M2ⱼ₃O₍₂₋ⱼ₄₎Fⱼ₅ (6)

In the formula (6), M2 represents at least one member selected from the group consisting of cobalt, magnesium, aluminum, boron, titanium, vanadium, chromium, iron, copper, zinc, zirconium, molybdenum, tin, calcium, strontium and tungsten; and j1, j2, j3, j4 and j5 represent values falling within the ranges of 0.8≦j1≦1.2, 0<j2<0.5, 0≦j3≦0.5, (j2+j3)<1, −0.1≦j4≦0.2 and 0≦j5≦0.1, respectively. The composition of lithium varies depending upon the state of charge and discharge, and the value of j1 represents a value in a completely discharged state.

Liₖ₁Ni₍₁₋ₖ₂₎M3ₖ₂O₍₂₋ₖ₃₎Fₖ₄ (7)

In the formula (7), M3 represents at least one member selected from the group consisting of cobalt, manganese, magnesium, aluminum, boron, titanium, vanadium, chromium, iron, copper, zinc, molybdenum, tin, calcium, strontium and tungsten; and k1, k2, k3 and k4 represent values falling within the ranges of 0.8≦k1≦1.2, 0.005≦k2≦0.5, −0.1≦k3≦0.2 and 0≦k4≦0.1, respectively. The composition of lithium varies depending upon the state of charge and discharge, and the value of k1 represents a value in a completely discharged state.

Li₁₁Mn₍₂₋₁₂₎M4₁₂O₁₃F₁₄ (8)

In the formula (8), M4 represents at least one member selected from the group consisting of cobalt, nickel, magnesium, aluminum, boron, titanium, vanadium, chromium, iron, copper, zinc, molybdenum, tin, calcium, strontium and tungsten; and l1, l2, l3 and l4 represent values falling within the ranges of 0.9≦l1≦1.1, 0≦l2≦0.6, 3.7≦l3≦4.1 and 0≦l4≦0.1, respectively. The composition of lithium varies depending upon the state of charge and discharge, and the value of l1 represents a value in a completely discharged state.

LiₚM5PO₄ (9)

In the formula (9), M5 represents at least one member selected from the group consisting of cobalt, manganese, iron, nickel, magnesium, aluminum, boron, titanium, vanadium, niobium, copper, zinc, molybdenum, calcium, strontium, tungsten and zirconium; and p represents a value falling within the range of 0.9≦p≦1.1. The composition of lithium varies depending upon the state of charge and discharge, and the value of p represents a value in a completely discharged state.

The positive electrode material capable of intercalating and deintercalating lithium may be formed as a complex particle obtained by coating the surface of a core particle composed of any one of the lithium-containing compounds represented by the foregoing formulae (5) to (9) by a fine particle composed of any one of these lithium-containing compounds. This is because higher electrode filling properties and cycle characteristic are obtainable.

The negative electrode 22 has, for example, a structure in which a negative electrode active material layer 22B is provided on the both surfaces of a negative electrode collector 22A having a pair of surfaces opposing to each other. While illustration is omitted, the negative electrode active material layer 22B may be provided on only one surface of the negative electrode collector 22A. The negative electrode collector 22A is constituted of a metal foil, for example, a copper foil, etc.

The negative electrode active material layer 22B is constituted so as to contain, as a negative electrode active material, one or two or more kinds of negative electrode materials capable of intercalating and deintercalating lithium and further contain the same binder as that in the positive electrode active material layer 21B, if desired.

In this nonaqueous electrolyte secondary battery, an electrochemical equivalent of the negative electrode material capable of intercalating and deintercalating lithium is larger than an electrochemical equivalent of the positive electrode 21, and a lithium metal does not theoretically deposit on the negative electrode 22 on the way of charge.

Also, this nonaqueous electrolyte secondary battery is designed such that an open circuit voltage (namely, a battery voltage) in a completely charged state falls within the range of, for example, 4.2 V or more and not more than 6.0 V. For example, in the case where the open circuit voltage in a fully charged state is 4.25 V or more, in comparison with a 4.2-V battery, even when the same positive electrode active material is concerned, a deintercalation amount of lithium per unit mass is large, and therefore, the amounts of the positive electrode material and the negative electrode material are regulated in response thereto, and a high energy density is obtainable.

Examples of the negative electrode material capable of intercalating and deintercalating lithium include carbon materials such as hardly graphitized carbon, easily graphitized carbon, graphite, pyrolytic carbons, cokes, vitreous carbons, organic polymer compound burned materials, carbon fibers and active carbon. Of these, examples of the cokes include pitch coke, needle coke and petroleum coke. The organic polymer compound burned material as referred to herein is a material obtained through carbonization by burning a polymer material such as phenol resins and furan resins at an appropriate temperature, and a part thereof is classified into hardly graphitized carbon or easily graphitized carbon. Such a carbon material is preferable because a change in the crystal structure to be generated at the time of charge and discharge is very small, a high charge and discharge capacity is obtainable, and a favorable cycle characteristic is obtainable. In particular, graphite is preferable because its electrochemical equivalent is large, and a high energy density is obtainable. Also, hardly graphitized carbon is preferable because an excellent cycle characteristic is obtainable. Moreover, a material having a low charge and discharge potential, specifically one having a charge and discharge potential close to a lithium metal, is preferable because it is easy to realize a high energy density of the battery.

Examples of the negative electrode material capable of intercalating and deintercalating lithium further include a material capable of intercalating and deintercalating lithium and containing, as a constituent element, at least one of a metal element and a semi-metal element. This is because by using such a material, a high energy density is obtainable. In particular, the joint use of such a material with the carbon material is more preferable because not only a high energy density is obtainable, but an excellent cycle characteristic is obtainable. This negative electrode material may be a simple substance, an alloy or a compound of a metal element or a semi-metal element. Also, the negative electrode material may be an electrode material having one or two or more kinds of such a phase in at least a part thereof. In the embodiment according to the present application, the alloy includes alloys containing at least one metal element and at least one semi-metal element in addition to alloys composed of two or more metal elements. Also, the negative electrode material may contain a non-metal element. Examples of its texture include a solid solution, a eutectic (eutectic mixture), an intermetallic compound and one in which two or more thereof coexist.

Examples of the metal element or semi-metal element which constitutes this negative electrode material include magnesium, boron, aluminum, gallium (Ga), indium (In), silicon (Si), germanium (Ge), tin, lead (Pb), bismuth (Bi), cadmium (Cd), silver (Ag), zinc, hafnium (Hf), zirconium, yttrium (Y), palladium (Pd) and platinum (Pt). These may be crystalline or amorphous.

Of these, ones containing, as a constituent element, a metal element or a semi-metal element belonging to the Group 4B in the short form of the periodic table are preferable, and ones containing, as a constituent element, at least one of silicon and tin are especially preferable as this negative electrode material. This is because silicon and tin have large capability of intercalating and deintercalating lithium, and a high energy density is obtainable.

Examples of alloys of tin include alloys containing, as a second constituent element other than tin, at least one member selected from the group consisting of silicon, nickel, copper, iron, cobalt, manganese, zinc, indium, silver, titanium (Ti), germanium, bismuth, antimony (Sb) and chromium. Examples of alloys of silicon include alloys containing, as a second constituent element other than silicon, at least one member selected from the group consisting of tin, nickel, copper, iron, cobalt, manganese, zinc, indium, silver, titanium, germanium, bismuth, antimony and chromium.

Examples of compounds of tin or compounds of silicon include compounds containing oxygen (O) or carbon (C), and these compounds may contain the foregoing second constituent element in addition to tin or silicon.

Of these, CoSnC-containing materials containing tin, cobalt and carbon as constituent elements and having a content of carbon of 9.9% by mass or more and not more than 29.7% by mass and a proportion of cobalt of 30% by mass or more and not more than 70% by mass relative to the total sum of tin and cobalt are preferable as this negative electrode material. This is because in the foregoing composition range, not only a high energy density is obtainable, but an excellent cycle characteristic is obtainable.

This CoSnC-containing material may further contain other constituent element, if desired. As such other constituent element, for example, silicon, iron, nickel, chromium, indium, niobium (Nb), germanium, titanium, molybdenum (Mo), aluminum, phosphorus (P), gallium (Ga) and bismuth are preferable, and two or more kinds of these elements may be contained. This is because the capacity or cycle characteristic can be more enhanced.

This CoSnC-containing material has a phase containing tin, cobalt and carbon, and it is preferable that this phase has a low crystalline or amorphous structure. Also, in this CoSnC-containing material, it is preferable that at least a part of carbon as the constituent element is bound to the metal element or semi-metal element as other constituent element. This is because though it may be considered that a lowering of the cycle characteristic is caused due to aggregation or crystallization of tin or the like, when carbon is bound to other element, such aggregation or crystallization can be suppressed.

Examples of a measurement method for examining the binding state of elements include X-ray photoelectron spectroscopy (XPS). In the XPS, so far as graphite is concerned, a peak of the 1s orbit (C1s) of carbon appears at 284.5 eV in an energy-calibrated device such that a peak of the 4f orbit of a gold atom (Au4f) is obtained at 84.0 eV. Also, so far as surface contamination carbon is concerned, a peak of the 1s orbit (C1s) of carbon appears at 284.8 eV. On the contrary, in the case where a charge density of the carbon element is high, for example, in the case where carbon is bound to the metal element or semi-metal element, the peak of C1s appears in a lower region than 284.5 eV. That is, in the case where a peak of a combined wave of C1s obtained regarding the CoSnC-containing material appears in a lower region than 284.5 eV, at least a part of carbon contained in the CoSnC-containing material is bound to the metal element or semi-metal element as other constituent element.

In the XPS measurement, for example, the peak of C1s is used for correcting the energy axis of a spectrum. In general, since surface contamination carbon exists on the surface, the peak of C1s of the surface contamination carbon is fixed at 284.8 eV, and this peak is used as an energy reference. In the XPS measurement, since a waveform of the peak of C1s is obtained as a form including the peak of the surface contamination carbon and the peak of carbon in the CoSnC-containing material, the peak of the surface contamination carbon and the peak of the carbon in the CoSnC-containing material are separated by means of analysis using, for example, a commercially available software. In the analysis of the waveform, the position of a main peak existing on the side of a lowest binding energy is used as an energy reference (284.8 eV).

The negative electrode active material layer 22B may further contain other negative electrode active material. Also, the negative electrode active material layer 22B may contain other material which does not contribute to the charge, such as a conductive agent, a binder and a viscosity modifier. Examples of other negative electrode active material include carbon materials such as natural graphite, artificial graphite, hardly graphitized carbon and easily graphitized carbon. Examples of the conductive agent include a graphite fiber, a metal fiber and a metal powder. Examples of the binder include fluorine based polymer compounds such as polyvinylidene fluoride; and synthetic rubbers such as a styrene-butadiene rubber and an ethylene-propylene-diene rubber. Examples of the viscosity modifier include carboxymethyl cellulose.

Furthermore, a porous heat-resistant layer containing an insulating metal oxide may be disposed on the negative electrode active material layer 22B.

It is preferable that the porous insulating layer contains an insulating metal oxide and a binder. It is preferable that the insulating metal oxide includes at least one member selected from the group consisting of alumina, silica, magnesia, titania and zirconia.

It is preferable that the binder includes at least one member selected from the group consisting of polyvinylidene fluoride (PVDF), polytetrafluoroethylene (PTFE), polyacrylonitrile (PAN), a styrene-butadiene rubber (SBR) and carboxymethyl cellulose (CMC).

The separator 23 partitions the positive electrode 21 and the negative electrode 22 from each other and allows a lithium ion to pass therethrough while preventing a short circuit of the current to be caused due to the contact of the both electrodes. The separator 23 is constituted of, for example, a porous film made of a synthetic resin such as polytetrafluoroethylene, polypropylene and polyethylene; or a porous film made of a ceramic. The separator 23 may have a structure in which two or more kinds of these porous films are laminated.

The separator 23 is impregnated with an electrolytic solution which is a liquid electrolyte. This electrolytic solution contains a solvent and an electrolyte salt dissolved in this solvent.

The separator 23 is constituted of a porous film made of a synthetic resin or a porous film made of a ceramic so as to contain any one of polypropylene, polyvinylidene fluoride, polytetrafluoroethylene, Al₂O₃ or SiO₂ other than polyethylene. A mixture of several kinds among polyethylene, polypropylene and polytetrafluoroethylene may be used as a porous film; Al₂O₃, polyvinylidene fluoride or SiO₂ may be coated on the surface of a porous film made of polyethylene, polypropylene or polytetrafluoroethylene; or two or more kinds of porous films of polyethylene, polypropylene and polytetrafluoroethylene may be laminated. A porous film made of a polyolefin is preferable because it is excellent in an effect for preventing a short circuit from occurring and is able to contrive to enhance the safety of a battery due to a shutdown effect.

This secondary battery can be, for example, manufactured by the following manner.

First of all, for example, the foregoing positive electrode active material is mixed with a conductive agent and a binder to prepare a positive electrode mixture, and this positive electrode mixture is dispersed in a solvent such as N-methyl-2-pyrrolidone, thereby preparing a positive electrode mixture slurry in a paste state. Subsequently, this positive electrode mixture slurry is coated on the positive electrode collector 21A, and the solvent is then dried. The resultant is compression molded by a roll press or the like to form the positive electrode active material layer 21B. There is thus formed the positive electrode 21.

Also, for example, the negative electrode active material is mixed with a binder to prepare a negative electrode mixture, and this negative electrode mixture is dispersed in a solvent such as N-methyl-2-pyrrolidone to prepare a negative electrode mixture slurry in a paste state. Subsequently, this negative electrode mixture slurry is coated on the negative electrode collector 22A, and the solvent is then dried. The resultant is compression molded by a roll press or the like to form the negative electrode active material layer 22B. There is thus prepared the negative electrode 22.

Subsequently, the positive electrode lead 25 is installed in the positive electrode collector 21A by means of welding or the like, and the negative electrode lead 26 is also installed in the negative electrode collector 22A by means of welding or the like. Thereafter, the positive electrode 21 and the negative electrode 22 are wound via the separator 23; a tip end of the positive electrode lead 25 is welded with the safety valve mechanism 15; and a tip end of the negative electrode lead 26 is also welded with the battery can 11. The wound positive electrode 21 and negative electrode 22 are interposed between a pair of the insulating plates 12 and 13 and housed in the inside of the battery can 11. After housing the positive electrode 21 and the negative electrode 22 in the inside of the battery can 11, an electrolytic solution is injected into the inside of the battery can 11 and impregnated in the separator 23. Thereafter, the battery lid 14, the safety valve mechanism 15 and the positive temperature coefficient device 16 are fixed to the open end of the battery can 11 upon being caulked via the gasket 17. There is thus formed the secondary battery shown in FIG. 1.

In this secondary battery, when charged, for example, a lithium ion is deintercalated from the positive electrode active material layer 21B and intercalated in the negative electrode active material layer 22B via the nonaqueous electrolyte. Also, when discharged, for example, a lithium ion is deintercalated from the negative electrode active material layer 22B and intercalated in the positive electrode active material layer 21B via the nonaqueous electrolyte.

In this way, according to the present embodiment, even when charge and discharge are repeated under a high-temperature condition or by increasing a battery voltage after charge to 4.25 V or more, not only corrosion of the positive electrode can be suppressed, but an increase of an impedance in the inside of the battery can be suppressed.

Thus, not only a battery with a high energy density can be achieved, but a cycle characteristic and a high-temperature characteristic can be enhanced.

### Second Embodiment

FIG. 3 shows a configuration of a secondary battery according to a second embodiment according to the present application. This secondary battery is called a so-called laminated film type and is one in which a wound electrode body 30 having a positive electrode lead 31 and a negative electrode lead 32 installed therein is housed in the inside of an exterior member 40 in a film state.

The positive electrode lead 31 and the negative electrode lead 32 are each led out in, for example, the same direction from the inside toward the outside of the exterior member 40. The positive electrode lead 31 and the negative electrode lead 32 are each constituted of a metal material, for example, aluminum, copper, nickel, stainless steel, etc. and formed in a thin plate state or a network state.

The exterior member 40 is constituted of, for example, a rectangular aluminum laminated film obtained by sticking a nylon film, an aluminum foil and a polyethylene film in this order. In the exterior member 40, for example, the side of the polyethylene film is disposed so as to be opposing to the wound electrode body 30, and the respective outer edges thereof are brought into intimate contact with each other by means of fusion or with an adhesive. A contact film 41 is inserted between the exterior member 40 and each of the positive electrode lead 31 and the negative electrode lead 32 for the purpose of preventing invasion of the outside air. The contact film 41 is constituted of a material having adhesion to each of the positive electrode lead 31 and the negative electrode lead 32, for example, polyolefin resins such as polyethylene, polypropylene, modified polyethylene and modified polypropylene.

The exterior member 40 may be constituted of a laminated film having other structure, a polymer film such as polypropylene or a metal film in place of the foregoing aluminum laminated film.

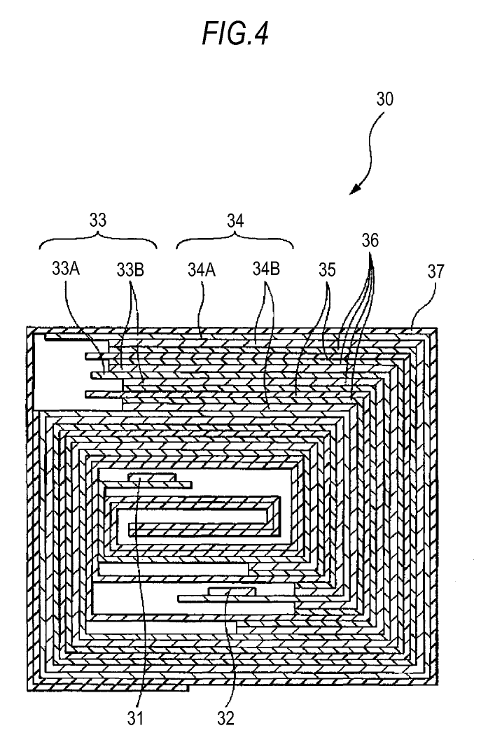

FIG. 4 shows a sectional structure along a VIII-VIII line of the wound electrode body 30 shown in FIG. 3. The wound electrode body 30 is one prepared by laminating a positive electrode 33 and a negative electrode 34 via a separator 35 and an electrolyte layer 36 and winding the laminate, and an outermost peripheral part thereof is protected by a protective tape 37.

The positive electrode 33 has a structure in which a positive electrode active material layer 33B is provided on one surface or both surfaces of a positive electrode collector 33A. The negative electrode 34 has a structure in which a negative electrode active material layer 34B is provided on one surface or both surfaces of a negative electrode collector 34A, and the negative electrode active material layer 34B and the positive electrode active material layer 33B are disposed opposing to each other. The configuration of each of the positive electrode collector 33A, the positive electrode active material layer 33B, the negative electrode collector 34A, the negative electrode active material layer 34B and the separator 35 is the same as the configuration of each of the positive electrode collector 21A, the positive electrode active material layer 21B, the negative electrode collector 22A, the negative electrode active material layer 22B and the separator 23 in the foregoing first embodiment.

The electrolyte layer 36 is the nonaqueous electrolyte according to the present embodiment, contains a nonaqueous electrolytic solution and a polymer compound serving as a holding material for holding the nonaqueous electrolytic solution therein and is formed in a so-called gel state. The electrolyte in a gel state is preferable because not only a high ionic conductivity is obtainable, but the liquid leakage of the battery can be prevented from occurring.

Examples of the polymer material include ether based polymer compounds such as polyethylene oxide and a crosslinked material containing polyethylene oxide; ester based polymer compounds such as polymethacrylates; acrylate based polymer compounds; and polymers of vinylidene fluoride such as polyvinylidene fluoride and a copolymer of vinylidene fluoride and hexafluoropropylene. These compounds may be used alone or in admixture of two or more kinds thereof. In particular, from the viewpoint of redox stability, it is desirable to use a fluorine based polymer compound such as polymers of vinylidene fluoride.

This secondary battery can be, for example, manufactured by the following manner.

First of all, a precursor solution containing an electrolytic solution, a polymer compound and a mixed solvent is coated on each of the positive electrode 33 and the negative electrode 34, and the mixed solvent is then vaporized to form the electrolyte layer 36. Thereafter, the positive electrode lead 31 is installed in an end of the positive electrode collector 33A by means of welding, and the negative electrode lead 32 is also installed in an end of the negative electrode collector 34A by means of welding. Subsequently, the positive electrode 33 and the negative electrode 34 each provided with the electrolyte layer 36 are laminated via the separator 35 to form a laminate, the laminate is then wound in a longitudinal direction thereof, and the protective tape 37 is allowed to adhere to the outermost peripheral part to form the wound electrode body 30. Finally, for example, the wound electrode body 30 is interposed between the exterior members 40, and the outer edges of the exterior members 40 are brought into intimate contact with each other by means of heat fusion or the like, thereby sealing the wound electrode body 30. On that occasion, the contact film 41 is inserted between each of the positive electrode lead 31 and the negative electrode lead 32 and the exterior member 40. According to this, the secondary battery shown in FIGS. 3 and 4 is completed.

Also, this secondary battery may be prepared in the following manner. First of all, the positive electrode 33 and the negative electrode 34 are prepared in the foregoing manner; the positive electrode lead 31 and the negative electrode lead 32 are installed in the positive electrode 33 and the negative electrode 34, respectively; the positive electrode 33 and the negative electrode 34 are then laminated via the separator 35 and wound; and the protective tape 37 is allowed to adhere to the outermost peripheral part to form a wound body which is a precursor of the wound electrode body 30. Subsequently, this wound body is interposed between the exterior members 40, and the outer edges exclusive of one side are subjected to heat fusion to form a bag and then housed in the inside of the exterior member 40. Subsequently, a composition for electrolyte containing an electrolytic solution, a monomer which is a raw material of the polymer compound, a polymerization initiator and optionally, other materials such as a polymerization inhibitor is prepared and injected into the inside of the exterior member 40.

After injecting the composition for electrolyte, an opening of the exterior member 40 is hermetically sealed by means of heat fusion in a vacuum atmosphere. Subsequently, the monomer is polymerized upon heating to form a polymer compound, thereby forming the electrolyte layer 36 in a gel state. There is thus assembled the secondary battery shown in FIGS. 3 and 4.

The actions and effects of this secondary battery are the same as those in the foregoing first embodiment.

### Examples

Specific working examples are hereunder described in detail, but it should not be construed that the present application is limited only to these working examples.

### Examples 1-1 to 1-5

The secondary battery shown in FIG. 1 was prepared.

First of all, 94 parts by mass of a lithium cobalt complex oxide as a positive electrode active material, 3 parts by mass of ketjen black (amorphous carbon powder) as a conductive agent and 3 parts by mass of polyvinylidene fluoride as a binder were mixed, and the mixture was dispersed in N-methyl-2-pyrrolidone as a solvent to prepare a positive electrode mixture slurry. Subsequently, this positive electrode mixture slurry was uniformly coated on the both surfaces of the positive electrode collector 21A made of a strip-shaped aluminum foil having a thickness of 20 μm, dried and then compression molded to form the positive electrode active material layer 21B. There was thus prepared the positive electrode 21. Thereafter, the positive electrode lead 25 made of aluminum was installed in one end of the positive electrode collector 21A.

Also, the negative electrode 22 was prepared in the following manner. First of all, 90 parts by mass of a graphite powder as a negative electrode active material and 10 parts by mass of polyvinylidene fluoride (PVdF) as a binder were mixed to prepare a negative electrode mixture. This negative electrode mixture was dispersed in N-methyl-2-pyrrolidone (NMP) to prepare a negative electrode mixture slurry; and the negative electrode mixture slurry was then uniformly coated on the both surfaces of the negative electrode collector 22A made of a strip-shaped copper foil and having a thickness of 15 μm and further heat press molded to form the negative electrode active material layer 22B. On that occasion, the amount of the positive electrode active material and the amount of the negative electrode active material were regulated so as to satisfy a condition of {(charge capacity of positive electrode)<(charge capacity of negative electrode)}, thereby designing an open circuit voltage (namely, a battery voltage) at the time of complete charge as shown in Table 1. The charge capacity as referred to herein means a capacity component due to intercalation and deintercalation of a light metal.

Subsequently, the negative electrode lead 26 made of nickel was installed in one end of the negative electrode collector 22A.

After preparing each of the positive electrode 21 and the negative electrode 22, the separator 23 made of a microporous film was prepared; the negative electrode 22, the separator 23, the positive electrode 21 and the separator 23 were laminated in this order; and the laminate was helically wound many times, thereby preparing the wound electrode body 20 of a jelly roll type having an outer diameter of 17.5 mm. On that occasion, a polyethylene separator having a thickness of 16 μm was used as the separator 23.

After preparing the wound electrode body 20, the wound electrode body 20 was interposed between a pair of the insulating plates 12 and 13; not only the negative electrode lead 26 was welded with the battery can 11, but the positive electrode lead 25 was welded with the safety valve mechanism 15; and the wound electrode body 20 was then housed in the inside of the battery can 11 made of nickel-plated iron. Subsequently, an electrolytic solution was injected into the inside of the battery can 11 in a reduced pressure mode. As a nonaqueous solvent used for the electrolytic solution, a mixed solvent obtained by mixing ethylene carbonate, propylene carbonate, dimethyl carbonate and ethyl methyl carbonate in a mass ratio of ethylene carbonate/propylene carbonate/dimethyl carbonate/ethyl methyl carbonate/4-fluoro-1,3-dioxolan-2-one (FEC) of 20/5/60/5/10 (each of values of a cyano compound, FEC and DFEC in Tables 1, 2 and 3 as described later is expressed in terms of a part by mass in the case of fixing the mass ratio of these ethylene carbonate, propylene carbonate, dimethyl carbonate and ethyl methyl carbonate and defining the amount of ethylene carbonate as 20 parts by mass). As an electrolyte salt, an electrolyte salt obtained by mixing LiPF₃(C₂F₅)₃ and LiPF₆ such that a molar fraction x of LiPF₃(C₂F₅)₃ occupying in the whole electrolyte salt satisfies a relationship of x=0.75 was used. On that occasion, the electrolytic solution was designed so as to have a total concentration of 1.2 moles/kg.

Thereafter, the battery lid 14 was caulked with the battery can 11 via the gasket 17, thereby preparing a secondary battery of a cylinder type having a diameter of 18 mm and a height of 65 mm.

### Example 1-6

A secondary battery was prepared in exactly the same manner as in Example 1-4, except that an electrolyte salt obtained by mixing LiPF₃(C₂F₅)₃ such that a molar fraction x of LiPF₃(C₂F₅)₃ occupying in the whole electrolyte salt satisfies a relationship of x=0.55 was used in the electrolyte salt to be used.

### Example 1-7

A secondary battery was prepared in exactly the same manner as in Example 1-4, except that an electrolyte salt obtained by mixing LiPF₃(C₂F₅)₃ such that a molar fraction x of LiPF₃(C₂F₅)₃ occupying in the whole electrolyte salt satisfies a relationship of x=0.65 was used in the electrolyte salt to be used.

### Example 1-8

A secondary battery was prepared in exactly the same manner as in Example 1-4, except that an electrolyte salt obtained by mixing LiPF₃(C₂F₅)₃ such that a molar fraction x of LiPF₃(C₂F₅)₃ occupying in the whole electrolyte salt satisfies a relationship of x=0.85 was used in the electrolyte salt to be used.

### Example 1-9

A secondary battery was prepared in exactly the same manner as in Example 1-4, except that an electrolyte salt obtained by mixing LiPF₃(C₂F₅)₃ such that a molar fraction x of LiPF₃(C₂F₅)₃ occupying in the whole electrolyte salt satisfies a relationship of x=0.95 was used in the electrolyte salt to be used.

### Example 1-10

A secondary battery was prepared in exactly the same manner as in Example 1-4, except that an electrolyte salt obtained by mixing LiPF₃(C₂F₅)₃ such that a molar fraction x of LiPF₃(C₂F₅)₃ occupying in the whole electrolyte salt satisfies a relationship of x=1.0 was used in the electrolyte salt to be used.

### Example 1-11

A secondary battery was prepared in exactly the same manner as in Example 1-4, except that LiPF₄(CF₃)₂ was used as the electrolyte to be used in place of LiPF₃(C₂F₅)₃.

### Example 1-12

A secondary battery was prepared in exactly the same manner as in Example 1-4, except that LiPF₄(C₂F₅)₂ was used as the electrolyte to be used in place of LiPF₃(C₂F₅)₃.

### Example 1-13

A secondary battery was prepared in exactly the same manner as in Example 1-4, except that LiPF₄(n-C₃F₇)₂ was used as the electrolyte to be used in place of LiPF₃(C₂F₅)₃. In the chemical formula, n-C₃F₇ expresses a propyl group having a linear structure.

### Example 1-14

A secondary battery was prepared in exactly the same manner as in Example 1-4, except that LiPF₄(i-C₃F₇)₂ was used as the electrolyte to be used in place of LiPF₃(C₂F₅)₃. In the chemical formula, i-C₃F₇ expresses a propyl group having a branched structure.

### Example 1-15

A secondary battery was prepared in exactly the same manner as in Example 1-4, except that LiPF₄(n-C₄F₉)₂ was used as the electrolyte to be used in place of LiPF₃(C₂F₅)₃. In the chemical formula, n-C₄F₉ expresses a butyl group having a linear structure.

### Example 1-16

A secondary battery was prepared in exactly the same manner as in Example 1-4, except that LiB(C₂F₅)₄ was used as the electrolyte to be used in place of LiPF₃(C₂F₅)₃.

### Example 1-17

A secondary battery was prepared in exactly the same manner as in Example 1-4, except that LiBF₂(C₂F₅)₂ was used as the electrolyte to be used in place of LiPF₃(C₂F₅)₃.

### Example 1-18

A secondary battery was prepared in exactly the same manner as in Example 1-4, except that LiBF₃(CF₃) was used as the electrolyte to be used in place of LiPF₃(C₂F₅)₃.

### Example 1-19

A secondary battery was prepared in exactly the same manner as in Example 1-4, except that LiBF₃(C₂F₅) was used as the electrolyte to be used in place of LiPF₃(C₂F₅)₃.

### Example 1-20

A secondary battery was prepared in exactly the same manner as in Example 1-4, except that LiBF₃(n-C₃F₇)₂ was used as the electrolyte to be used in place of LiPF₃(C₂F₅)₃. In the chemical formula, n-C₃F₇ expresses a propyl group having a linear structure.

### Example 1-21

A secondary battery was prepared in exactly the same manner as in Example 1-4, except that LiBF₄ was used as the electrolyte to be used in place of LiPF₆.

### Example 1-22

A secondary battery was prepared in exactly the same manner as in Example 1-4, except that LiAsF₆ was used as the electrolyte to be used in place of LiPF₆.

### Example 1-23

A secondary battery was prepared in exactly the same manner as in Example 1-4, except that LiC(CF₃SO₂)₃ was used as the electrolyte to be used in place of LiPF₆.

### Example 1-24

A secondary battery was prepared in exactly the same manner as in Example 1-4, except that LiN(FSO₂)₂ was used as the electrolyte to be used in place of LiPF₆.

### Example 1-25

A secondary battery was prepared in exactly the same manner as in

Example 1-4, except that LiN(CF₃SO₂)₂ was used as the electrolyte to be used in place of LiPF₆.

### Example 1-26

A secondary battery was prepared in exactly the same manner as in Example 1-4, except that LiN(C₂F₅SO₂)₂ was used as the electrolyte to be used in place of LiPF₆.

### Example 1-27

A secondary battery was prepared in exactly the same manner as in Example 1-4, except that LiN(n-C₃F₇SO₂)₂ was used as the electrolyte to be used in place of LiPF₆. In the chemical formula, n-C₃F₇ expresses a propyl group having a linear structure.

### Example 1-28

A secondary battery was prepared in exactly the same manner as in Example 1-4, except that LiN(n-C₄F₉SO₂)₂ was used as the electrolyte to be used in place of LiPF₆. In the chemical formula, n-C₄F₉ expresses a butyl group having a linear structure.

### Example 1-29

A secondary battery was prepared in exactly the same manner as in Example 1-4, except that the cyclic imide salt represented by the foregoing formula (4a) was used as the electrolyte to be used in place of LiPF₆.

### Example 1-30

A secondary battery was prepared in exactly the same manner as in Example 1-4, except that the cyclic imide salt represented by the foregoing formula (4b) was used as the electrolyte to be used in place of LiPF₆.

### Example 1-31

A secondary battery was prepared in exactly the same manner as in Example 1-4, except that 2 parts by mass of succinonitrile was added in the nonaqueous electrolytic solution.

### Example 1-32

A secondary battery was prepared in exactly the same manner as in Example 1-4, except that 4,5-difluoro-1,3-dioxolan-2-one (DFEC) was used as the nonaqueous solvent in the nonaqueous electrolyte in place of 4-fluoro-1,3-dioxolan-2-one (FEC).

### Example 1-33

A secondary battery was prepared in exactly the same manner as in Example 1-4, except that 4-fluoro-1,3-dioxolan-2-one was not contained as the nonaqueous solvent in the nonaqueous electrolyte. The molar fraction of other nonaqueous solvents was designed to be the same as in Example 1-4.

### Comparative Examples 1-1 to 1-5

Secondary batteries were prepared in exactly the same manners as in Examples 1-1 to 1-5, respectively, except that an electrolyte salt obtained by mixing LiPF₃(C₂F₅)₃ and LiPF₆ such that a molar fraction x of LiPF₃(C₂F₅)₃ occupying in the whole electrolyte salt satisfies a relationship of x=0.25 was used as the electrolyte salt to be used.

### Comparative Example 1-6

A secondary battery was prepared in exactly the same manner as in Example 1-4, except that an electrolyte salt obtained by mixing LiPF₃(C₂F₅)₃ and LiPF₆ such that a molar fraction x of LiPF₃(C₂F₅)₃ occupying in the whole electrolyte salt satisfies a relationship of x=0 was used as the electrolyte salt to be used.

### Comparative Example 1-7

A secondary battery was prepared in exactly the same manner as in

Example 1-4, except that an electrolyte salt obtained by mixing LiPF₃(C₂F₅)₃ and LiPF₆ such that a molar fraction x of LiPF₃(C₂F₅)₃ occupying in the whole electrolyte salt satisfies a relationship of x=0.5 was used as the electrolyte salt to be used.

### Comparative Example 1-8

A secondary battery was prepared in exactly the same manner as in Comparative Example 1-4, except that LiPF₄(CF₃)₂ was used as the electrolyte salt to be used in place of LiPF₃(C₂F₅)₃.

### Comparative Example 1-9

A secondary battery was prepared in exactly the same manner as in Comparative Example 1-4, except that LiPF₄(C₂F₅)₂ was used as the electrolyte salt to be used in place of LiPF₃(C₂F₅)₃.

### Comparative Example 1-10

A secondary battery was prepared in exactly the same manner as in Comparative Example 1-4, except that LiPF₄(n-C₃F₇)₂ was used as the electrolyte salt to be used in place of LiPF₃(C₂F₅)₃. In the chemical formula, n-C₃F₇ expresses a propyl group having a linear structure.

### Comparative Example 1-11

A secondary battery was prepared in exactly the same manner as in Comparative Example 1-4, except that LiPF₄(i-C₃F₇)₂ was used as the electrolyte salt to be used in place of LiPF₃(C₂F₅)₃. In the chemical formula, i-C₃F₇ expresses a propyl group having a branched structure.

### Comparative Example 1-12

A secondary battery was prepared in exactly the same manner as in Comparative Example 1-4, except that LiPF₄(n-C₄F₉)₂ was used as the electrolyte salt to be used in place of LiPF₃(C₂F₅)₃. In the chemical formula, n-C₄F₉ expresses a butyl group having a linear structure.

### Comparative Example 1-13

A secondary battery was prepared in exactly the same manner as in Comparative Example 1-4, except that LiB(C₂F₅)₄ was used as the electrolyte salt to be used in place of LiPF₃(C₂F₅)₃.

### Comparative Example 1-14

A secondary battery was prepared in exactly the same manner as in Comparative Example 1-4, except that LiBF₂(C₂F₅)₂ was used as the electrolyte salt to be used in place of LiPF₃(C₂F₅)₃.

### Comparative Example 1-15

A secondary battery was prepared in exactly the same manner as in Comparative Example 1-4, except that LiBF₃(CF₃) was used as the electrolyte salt to be used in place of LiPF₃(C₂F₅)₃.

### Comparative Example 1-16

A secondary battery was prepared in exactly the same manner as in Comparative Example 1-4, except that LiBF₃(C₂F₅) was used as the electrolyte salt to be used in place of LiPF₃(C₂F₅)₃.

### Comparative Example 1-17

A secondary battery was prepared in exactly the same manner as in Comparative Example 1-4, except that LiBF₃(n-C₃F₇) was used as the electrolyte salt to be used in place of LiPF₃(C₂F₅)₃. In the chemical formula, n-C₃F₇ expresses a propyl group having a linear structure.

### Comparative Example 1-18

A secondary battery was prepared in exactly the same manner as in Comparative Example 1-4, except that LiBF₄ was used as the electrolyte salt to be used in place of LiPF₆.

### Comparative Example 1-19

A secondary battery was prepared in exactly the same manner as in Comparative Example 1-4, except that LiAsF₆ was used as the electrolyte salt to be used in place of LiPF₆.

### Comparative Example 1-20

A secondary battery was prepared in exactly the same manner as in Comparative Example 1-4, except that LiN(CF₃SO₂)₂ was used as the electrolyte salt to be used in place of LiPF₆.

### Comparative Example 1-21

A secondary battery was prepared in exactly the same manner as in Comparative Example 1-4, except that LiC(CF₃SO₂)₃ was used as the electrolyte salt to be used in place of LiPF₆.

The thus prepared secondary batteries of the Examples and Comparative Examples were evaluated with respect to a recovery capacity (%) after high-temperature continuous charge, a capacity retention rate (%) after 300 cycles and a capacity retention rate (%) after 200 cycles of overcharge cycle and subsequent 100 cycles of usual cycle test in the following methods.

Measurement of recovery capacity (%) after high-temperature continuous charge test

First of all, charge and discharge were carried out in an atmosphere at 70° C., and a discharge capacity before continuous charge was measured. Subsequently, continuous charge was carried out in an atmosphere at 70° C. for 72 hours; discharge was then carried out; and after again carrying out charge and discharge, a discharge capacity after continuous charge was determined. A recovery capacity was calculated from the determined discharge capacity according to the following expression.

Recovery capacity (%)={(Discharge capacity after continuous charge)/(Discharge capacity before continuous charge)}×100 (%)

Charge and discharge were carried out under the same condition other than continuous charge; charge was carried out at a constant-current density of 1 mA/cm² until the battery voltage reached a prescribed voltage, and then constant-voltage charge was carried out at a prescribed battery voltage until the current density reached 0.02 mA/cm²; and discharge was carried out at a constant-current density of 1 mA/cm² until the battery voltage reached 3.0 V. The continuous charge was carried out at a constant-current density of 1 mA/cm² until the battery voltage reached a prescribed voltage and then carried out at a prescribed battery voltage until a total time reached 72 hours. The prescribed battery voltage is set to be a charge voltage shown in Tables 1 and 2.

Measurement of Capacity Retention Rate (%) After 300 Cycles

Charge was carried out in an atmosphere at 25° C. at a constant-current density of 1 mA/cm² until the battery voltage reached a prescribed voltage, and then constant-voltage charge was carried out at a prescribed voltage until the current density reached 0.02 mA/cm²; and discharge was carried out at a constant-current density of 1 mA/cm² until the battery voltage reached 3.0 V, thereby measuring an initial capacity. Furthermore, charge and discharge were repeated under the same condition as in the case of determining an initial capacity, thereby measuring a discharge capacity at the 300th cycle. A capacity retention rate (%) relative to the initial capacity was calculated from the determined discharge capacity according to the following expression. The prescribed battery voltage is set to be a charge voltage shown in Tables 1 and 2.

Capacity retention rate (%) after 300 cycles={(Discharge capacity after 300 cycles)/(Initial capacity)}×100 (%)

Measurement of Capacity Retention Rate (%) After Overcharge Cycle and Usual Cycle

Charge was carried out in an atmosphere at 25° C. at a constant-current density of 1 mA/cm² until the battery voltage reached a prescribed voltage, and then constant-voltage charge was carried out at the instant battery voltage until the current density reached 0.02 mA/cm²; and discharge was carried out at a constant-current density of 1 mA/cm² until the battery voltage reached 3.0 V, thereby measuring an initial capacity.

### (Overcharge Cycle)

Subsequently, 200 cycles were carried out in the following manner. Charge was carried out in an atmosphere at 25° C. at a constant-current density of 1 mA/cm² until the battery voltage reached a voltage higher than a prescribed battery voltage by 50 mA, and then constant-voltage charge was carried out at the instant battery voltage until the current density reached 0.02 mA/cm²; and discharge was carried out at a constant-current density of 1 mA/cm² until the battery voltage reached 3.0 V. Furthermore, charge and discharge were repeated 200 cycles under the same condition. Even when the battery was charged to a voltage higher than the prescribed battery voltage by 50 mV, a relationship of {(charge capacity of positive electrode)<(charge capacity of negative electrode)} was maintained. The charge capacity as referred to herein means a capacity component due to intercalation and deintercalation of a light metal.

### (Usual Cycle)

Subsequently, the charge and discharge condition under which the initial capacity was determined was repeated 100 cycles, and thereafter, a discharge capacity after 100 cycles was measured. A capacity retention rate (%) relative to the determined initial capacity of discharge capacity was calculated according to the following expression. The prescribed battery voltage is set to be a charge voltage shown in Tables 1 and 2.

Capacity retention rate (%) after overcharge cycle and usual cycle={(Discharge capacity after usual cycle)/(Initial capacity)}×100 (%)

| | | | | | | | | | | | Capacity |
|---|---|---|---|---|---|---|---|---|---|---|---|
| | | | | | | | | | Recovery | | retention rate |
| | | | | | | | | | capacity | | (%) after |
| | | | Electrolyte | | | | | | (%) after | Capacity | 200 cycles of |
| | | | salt other | | | | | | high- | retention | overcharge |
| | Electrolyte | Molar | than that of | Molar | | | | | temperature | rate | and 100 |
| | salt of the | fraction | the formula | fraction | Charge | Cyano | | | continuous | (%) after | cycles of |
| | formula (1) or (2) | of A | (1) or (2) | of B | voltage | compound | FEC | DFEC | charge test | 300 cycles | usual charge |
| Comparative | LiPF₃(C₂F₅)₃ | 0.25 | LiPF₆ | 0.75 | 4.20 | 0 | 10 | 0 | 80 | 88 | 79 |
| Example 1-1 | | | | | | | | | | | |
| Comparative | LiPF₃(C₂F₅)₃ | 0.25 | LiPF₆ | 0.75 | 4.25 | 0 | 10 | 0 | 75 | 83 | 73 |
| Example 1-2 | | | | | | | | | | | |
| Comparative | LiPF₃(C₂F₅)₃ | 0.25 | LiPF₆ | 0.75 | 4.35 | 0 | 10 | 0 | 69 | 74 | 63 |
| Example 1-3 | | | | | | | | | | | |
| Comparative | LiPF₃(C₂F₅)₃ | 0.25 | LiPF₆ | 0.75 | 4.45 | 0 | 10 | 0 | 62 | 64 | 52 |
| Example 1-4 | | | | | | | | | | | |
| Comparative | LiPF₃(C₂F₅)₃ | 0.25 | LiPF₆ | 0.75 | 4.55 | 0 | 10 | 0 | 55 | 53 | 40 |
| Example 1-5 | | | | | | | | | | | |
| Comparative | LiPF₃(C₂F₅)₃ | 0 | LiPF₆ | 1.0 | 4.45 | 0 | 10 | 0 | 57 | 60 | 48 |
| Example 1-6 | | | | | | | | | | | |
| Comparative | LiPF₃(C₂F₅)₃ | 0.5 | LiPF₆ | 0.5 | 4.45 | 0 | 10 | 0 | 64 | 65 | 54 |
| Example 1-7 | | | | | | | | | | | |
| Comparative | LiPF₄(CF₃)₂ | 0.25 | LiPF₆ | 0.75 | 4.45 | 0 | 10 | 0 | 61 | 61 | 50 |
| Example 1-8 | | | | | | | | | | | |
| Comparative | LiPF₄(C₂F₅)₂ | 0.25 | LiPF₆ | 0.75 | 4.45 | 0 | 10 | 0 | 63 | 64 | 50 |
| Example 1-9 | | | | | | | | | | | |
| Comparative | LiPF₄(n-C₃F₇)₂ | 0.25 | LiPF₆ | 0.75 | 4.45 | 0 | 10 | 0 | 60 | 60 | 49 |
| Example 1-10 | | | | | | | | | | | |
| Comparative | LiPF₄(i-C₃F₇)₂ | 0.25 | LiPF₆ | 0.75 | 4.45 | 0 | 10 | 0 | 62 | 62 | 52 |
| Example 1-11 | | | | | | | | | | | |
| Comparative | LiPF₄(n-C₄F₉)₂ | 0.25 | LiPF₆ | 0.75 | 4.45 | 0 | 10 | 0 | 61 | 60 | 52 |
| Example 1-12 | | | | | | | | | | | |
| Comparative | LiB(C₂F₅)₄ | 0.25 | LiPF₆ | 0.75 | 4.45 | 0 | 10 | 0 | 60 | 63 | 53 |
| Example 1-13 | | | | | | | | | | | |
| Comparative | LiBF₂(C₂F₅)₂ | 0.25 | LiPF₆ | 0.75 | 4.45 | 0 | 10 | 0 | 63 | 61 | 51 |
| Example 1-14 | | | | | | | | | | | |
| Comparative | LiBF₃(CF₃) | 0.25 | LiPF₆ | 0.75 | 4.45 | 0 | 10 | 0 | 61 | 62 | 52 |
| Example 1-15 | | | | | | | | | | | |
| Comparative | LiBF₃(C₂F₅) | 0.25 | LiPF₆ | 0.75 | 4.45 | 0 | 10 | 0 | 63 | 62 | 51 |
| Example 1-16 | | | | | | | | | | | |
| Comparative | LiBF₃(n-C₃F₇) | 0.25 | LiPF₆ | 0.75 | 4.45 | 0 | 10 | 0 | 63 | 64 | 52 |
| Example 1-17 | | | | | | | | | | | |
| Comparative | LiPF₃(C₂F₅)₃ | 0.25 | LiBF₄ | 0.75 | 4.45 | 0 | 10 | 0 | 60 | 63 | 51 |
| Example 1-18 | | | | | | | | | | | |
| Comparative | LiPF₃(C₂F₅)₃ | 0.25 | LiAsF₆ | 0.75 | 4.45 | 0 | 10 | 0 | 59 | 61 | 49 |
| Example 1-19 | | | | | | | | | | | |
| Comparative | LiPF₃(C₂F₅)₃ | 0.25 | LiN(CF₃SO₂)₂ | 0.75 | 4.45 | 0 | 10 | 0 | 63 | 65 | 52 |
| Example 1-20 | | | | | | | | | | | |
| Comparative | LiPF₃(C₂F₅)₃ | 0.25 | LiC(CF₃SO₂)₃ | 0.75 | 4.45 | 0 | 10 | 0 | 65 | 62 | 50 |
| Example 1-21 | | | | | | | | | | | |
| Comparative | LiPF3(C2F5)3 | 0.25 | LiPF6 | 0.75 | 4.20 | 0 | 10 | 0 | 80 | 88 | 79 |
| Example 1-1 | | | | | | | | | | | |
| Comparative | LiPF3(C2F5)3 | 0.25 | LiPF6 | 0.75 | 4.25 | 0 | 10 | 0 | 75 | 83 | 73 |
| Example 1-2 | | | | | | | | | | | |
| Comparative | LiPF3(C2F5)3 | 0.25 | LiPF6 | 0.75 | 4.35 | 0 | 10 | 0 | 69 | 74 | 63 |
| Example 1-3 | | | | | | | | | | | |
| Comparative | LiPF3(C2F5)3 | 0.25 | LiPF6 | 0.75 | 4.45 | 0 | 10 | 0 | 62 | 64 | 52 |
| Example 1-4 | | | | | | | | | | | |
| Comparative | LiPF3(C2F5)3 | 0.25 | LiPF6 | 0.75 | 4.55 | 0 | 10 | 0 | 55 | 53 | 40 |
| Example 1-5 | | | | | | | | | | | |
| Comparative | LiPF3(C2F5)3 | 0 | LiPF6 | 1.0 | 4.45 | 0 | 10 | 0 | 57 | 60 | 48 |
| Example 1-6 | | | | | | | | | | | |
| Comparative | LiPF3(C2F5)3 | 0.5 | LiPF6 | 0.5 | 4.45 | 0 | 10 | 0 | 64 | 65 | 54 |
| Example 1-7 | | | | | | | | | | | |
| Comparative | LiPF4(CF3)2 | 0.25 | LiPF6 | 0.75 | 4.45 | 0 | 10 | 0 | 61 | 61 | 50 |
| Example 1-8 | | | | | | | | | | | |
| Comparative | LiPF4(C2F5)2 | 0.25 | LiPF6 | 0.75 | 4.45 | 0 | 10 | 0 | 63 | 64 | 50 |
| Example 1-9 | | | | | | | | | | | |
| Comparative | LiPF4(n-C3F7)2 | 0.25 | LiPF6 | 0.75 | 4.45 | 0 | 10 | 0 | 60 | 60 | 49 |
| Example 1-10 | | | | | | | | | | | |
| Comparative | LiPF4(i-C3F7)2 | 0.25 | LiPF6 | 0.75 | 4.45 | 0 | 10 | 0 | 62 | 62 | 52 |
| Example 1-11 | | | | | | | | | | | |
| Comparative | LiPF4(n-C4F9)2 | 0.25 | LiPF6 | 0.75 | 4.45 | 0 | 10 | 0 | 61 | 60 | 52 |
| Example 1-12 | | | | | | | | | | | |
| Comparative | LiB(C2F5)4 | 0.25 | LiPF6 | 0.75 | 4.45 | 0 | 10 | 0 | 60 | 63 | 53 |
| Example 1-13 | | | | | | | | | | | |
| Comparative | LiBF2(C2F5)2 | 0.25 | LiPF6 | 0.75 | 4.45 | 0 | 10 | 0 | 63 | 61 | 51 |
| Example 1-14 | | | | | | | | | | | |
| Comparative | LiBF3(CF3) | 0.25 | LiPF6 | 0.75 | 4.45 | 0 | 10 | 0 | 61 | 62 | 52 |
| Example 1-15 | | | | | | | | | | | |
| Comparative | LiBF3(C2F5) | 0.25 | LiPF6 | 0.75 | 4.45 | 0 | 10 | 0 | 63 | 62 | 51 |
| Example 1-16 | | | | | | | | | | | |
| Comparative | LiBF3(n-C3F7) | 0.25 | LiPF6 | 0.75 | 4.45 | 0 | 10 | 0 | 63 | 64 | 52 |
| Example 1-17 | | | | | | | | | | | |
| Comparative | LiPF3(C2F5)3 | 0.25 | LiBF4 | 0.75 | 4.45 | 0 | 10 | 0 | 60 | 63 | 51 |
| Example 1-18 | | | | | | | | | | | |
| Comparative | LiPF3(C2F5)3 | 0.25 | LiAsF6 | 0.75 | 4.45 | 0 | 10 | 0 | 59 | 61 | 49 |
| Example 1-19 | | | | | | | | | | | |
| Comparative | LiPF3(C2F5)3 | 0.25 | LiN(CF3SO2)2 | 0.75 | 4.45 | 0 | 10 | 0 | 63 | 65 | 52 |
| Example 1-20 | | | | | | | | | | | |
| Comparative | LiPF3(C2F5)3 | 0.25 | LiC(CF3SO2)3 | 0.75 | 4.45 | 0 | 10 | 0 | 65 | 62 | 50 |
| Example 1-21 | | | | | | | | | | | |

When Examples 1-1 to 1-10 are compared with Comparative Examples 1-1 to 1-7, it is noted that in the case where the molar fraction x of LiPF₃(C₂F₅)₃ as one of the electrolyte salts used upon being mixed with lithium hexafluorophosphate, which occupies in the whole electrolyte salt, satisfies a relationship of (x>0.5), the cycle characteristic after overcharge cycle and the capacity retention rate after high-temperature continuous charge are significantly enhanced as compared with the case of (x≦5). Also, it is noted that as the charge final voltage increases, the effects are more enhanced. It may be considered that this is caused due to the fact that corrosion of the positive electrode is suppressed.

When Examples 1-11 to 1-20 are compared with Comparative Examples 1-8 to 1-18, it is noted that in the case where any one of lithium fluoroalkyl phosphates or lithium fluoroalkyl borates other than LiPF₃(C₂F₅)₃ is used as the electrolyte salt to be used, when the molar fraction of the electrolyte salt occupying in the whole electrolyte salt is larger than 0.5, excellent effects are similarly obtainable. It may be strongly conjectured that even when plural kinds of electrolyte salts are used, the effects are naturally obtainable.

When Example 1-4 is compared with Comparative Examples 1-19 to 1-22, it is noted that even by using a combination with a generally used electrolyte salt other than lithium hexafluorophosphate, in the case where the molar fraction of the lithium fluoroalkyl phosphate occupying in the whole electrolyte salt is not more than 0.5, it may be impossible to obtain sufficient effects, too.

When Example 1-4 is compared with Examples 1-21 to 1-30, it is noted that what the chain or cyclic imide salt is mixed in addition to LiPF₃(C₂F₅)₃ is especially preferable because both the capacity retention rate after high-temperature continuous charge and the cycle characteristic are enhanced.

When Example 1-4 is compared with Example 1-31, it is noted that when the electrolyte contains a cyano compound, the capacity retention rate after high-temperature continuous charge is significantly enhanced.

When Example 1-4 is compared with Examples 1-32 and 1-33, it is noted that what the electrolyte contains a halogen atom-containing cyclic carbonate is more preferable.

### Examples 2-1 to 2-12

Secondary batteries were prepared in the same manner as in Example 1-4, except that the composition of the solvent in the electrolytic solution was changed as shown in Table 3. In Examples 2-1 to 2-7, the content of 4-fluoro-1,3-dioxolan-2-one (FEC) which is a halogen atom-containing cyclic carbonate was successively increased. Also, in Examples 2-8 to 2-12, the content of succinonitrile which is a cyano compound was successively increased.

### Comparative Examples 2-1 to 2-13

In relation to Examples 2-1 to 2-12, in Comparative Examples 2-1 to 2-13, secondary batteries were prepared in the same manner as in Comparative Example 1-4, except that the composition of the solvent in the electrolytic solution was changed as shown in Table 3.

| | | | | | | | | | | | Capacity |
|---|---|---|---|---|---|---|---|---|---|---|---|
| | | | | | | | | | Recovery | | retention rate |
| | | | | | | | | | capacity | | (%) after |
| | | | Electrolyte | | | | | | (%) after | Capacity | 200 cycles of |
| | | | salt other | | | | | | high- | retention | overcharge |
| | Electrolyte | Molar | than that of | Molar | | | | | temperature | rate | and 100 |
| | salt of the | fraction | the formula | fraction | Charge | Cyano | | | continuous | (%) after | cycles of |
| | formula (1) or (2) | of A | (1) or (2) | of B | voltage | compound | FEC | DFEC | charge test | 300 cycles | usual charge |
| Example 2-1 | LiPF₃(C₂F₅)₃ | 0.75 | LiPF₆ | 0.25 | 4.45 | 0 | 0.01 | 0 | 71 | 73 | 60 |
| Example 2-2 | LiPF₃(C₂F₅)₃ | 0.75 | LiPF₆ | 0.25 | 4.45 | 0 | 1 | 0 | 72 | 74 | 62 |
| Example 2-3 | LiPF₃(C₂F₅)₃ | 0.75 | LiPF₆ | 0.25 | 4.45 | 0 | 2 | 0 | 73 | 76 | 61 |
| Example 2-4 | LiPF₃(C₂F₅)₃ | 0.75 | LiPF₆ | 0.25 | 4.45 | 0 | 5 | 0 | 72 | 78 | 61 |
| Example 1-4 | LiPF₃(C₂F₅)₃ | 0.75 | LiPF₆ | 0.25 | 4.45 | 0 | 10 | 0 | 73 | 77 | 62 |
| Example 2-5 | LiPF₃(C₂F₅)₃ | 0.75 | LiPF₆ | 0.25 | 4.45 | 0 | 20 | 0 | 72 | 79 | 63 |
| Example 2-6 | LiPF₃(C₂F₅)₃ | 0.75 | LiPF₆ | 0.25 | 4.45 | 0 | 30 | 0 | 71 | 74 | 60 |
| Example 2-7 | LiPF₃(C₂F₅)₃ | 0.75 | LiPF₆ | 0.25 | 4.45 | 0 | 40 | 0 | 70 | 70 | 59 |
| Example 2-8 | LiPF₃(C₂F₅)₃ | 0.75 | LiPF₆ | 0.25 | 4.45 | 0.01 | 10 | 0 | 71 | 70 | 61 |
| Example 2-9 | LiPF₃(C₂F₅)₃ | 0.75 | LiPF₆ | 0.25 | 4.45 | 1 | 10 | 0 | 74 | 76 | 64 |
| Example 1-31 | LiPF₃(C₂F₅)₃ | 0.75 | LiPF₆ | 0.25 | 4.45 | 2 | 10 | 0 | 76 | 75 | 66 |
| Example 2-10 | LiPF₃(C₂F₅)₃ | 0.75 | LiPF₆ | 0.25 | 4.45 | 5 | 10 | 0 | 77 | 73 | 64 |
| Example 2-11 | LiPF₃(C₂F₅)₃ | 0.75 | LiPF₆ | 0.25 | 4.45 | 10 | 10 | 0 | 72 | 70 | 63 |
| Example 2-12 | LiPF₃(C₂F₅)₃ | 0.75 | LiPF₆ | 0.25 | 4.45 | 15 | 10 | 0 | 70 | 69 | 59 |
| Comparative | LiPF₃(C₂F₅)₃ | 0.25 | LiPF₆ | 0.75 | 4.45 | 0 | 0.01 | 0 | 58 | 59 | 47 |
| Example 2-1 | | | | | | | | | | | |
| Comparative | LiPF₃(C₂F₅)₃ | 0.25 | LiPF₆ | 0.75 | 4.45 | 0 | 1 | 0 | 61 | 60 | 48 |
| Example 2-2 | | | | | | | | | | | |
| Comparative | LiPF₃(C₂F₅)₃ | 0.25 | LiPF₆ | 0.75 | 4.45 | 0 | 2 | 0 | 62 | 60 | 50 |
| Example 2-3 | | | | | | | | | | | |
| Comparative | LiPF₃(C₂F₅)₃ | 0.25 | LiPF₆ | 0.75 | 4.45 | 0 | 5 | 0 | 63 | 61 | 51 |
| Example 2-4 | | | | | | | | | | | |
| Comparative | LiPF₃(C₂F₅)₃ | 0.25 | LiPF₆ | 0.75 | 4.45 | 0 | 10 | 0 | 62 | 64 | 52 |
| Example 1-4 | | | | | | | | | | | |
| Comparative | LiPF₃(C₂F₅)₃ | 0.25 | LiPF₆ | 0.75 | 4.45 | 0 | 20 | 0 | 63 | 62 | 51 |
| Example 2-5 | | | | | | | | | | | |
| Comparative | LiPF₃(C₂F₅)₃ | 0.25 | LiPF₆ | 0.75 | 4.45 | 0 | 30 | 0 | 60 | 61 | 48 |
| Example 2-6 | | | | | | | | | | | |
| Comparative | LiPF₃(C₂F₅)₃ | 0.25 | LiPF₆ | 0.75 | 4.45 | 0 | 40 | 0 | 59 | 59 | 46 |
| Example 2-7 | | | | | | | | | | | |
| Comparative | LiPF₃(C₂F₅)₃ | 0.25 | LiPF₆ | 0.75 | 4.45 | 0.01 | 10 | 0 | 62 | 64 | 52 |
| Example 2-8 | | | | | | | | | | | |
| Comparative | LiPF₃(C₂F₅)₃ | 0.25 | LiPF₆ | 0.75 | 4.45 | 1 | 10 | 0 | 61 | 65 | 53 |
| Example 2-9 | | | | | | | | | | | |
| Comparative | LiPF₃(C₂F₅)₃ | 0.25 | LiPF₆ | 0.75 | 4.45 | 2 | 10 | 0 | 63 | 65 | 53 |
| Example 2-10 | | | | | | | | | | | |
| Comparative | LiPF₃(C₂F₅)₃ | 0.25 | LiPF₆ | 0.75 | 4.45 | 5 | 10 | 0 | 63 | 61 | 50 |
| Example 2-11 | | | | | | | | | | | |
| Comparative | LiPF₃(C₂F₅)₃ | 0.25 | LiPF₆ | 0.75 | 4.45 | 10 | 10 | 0 | 60 | 58 | 49 |
| Example 2-12 | | | | | | | | | | | |
| Comparative | LiPF₃(C₂F₅)₃ | 0.25 | LiPF₆ | 0.75 | 4.45 | 15 | 10 | 0 | 59 | 57 | 45 |
| Example 2-13 | | | | | | | | | | | |

When Examples 2-1 to 2-7 are compared with Comparative Examples 2-1 to 2-7, it is noted that the content of the halogen atom-containing cyclic carbonate is preferably in the range of 0.01 parts by mass or more and not more than 30 parts by mass, and especially preferably in the range of 5 parts by mass or more and not more than 20 parts by mass. Also, even when the content of the halogen atom-containing cyclic carbonate is increased, it is difficult to obtain the sufficient effects unless the molar fraction of the lithium fluoroalkyl phosphate occupying in the whole electrolyte salt exceeds 0.5.

When Examples 2-8 to 2-12 are compared with Comparative Examples 2-8 to 2-13, it is noted that the content of the cyano group-containing compound is preferably in the range of 0.01 parts by mass or more and not more than 10 parts by mass, and especially preferably in the range of 0.01 parts by mass or more and not more than 5 parts by mass. Also, even when the content of the cyano group-containing compound is increased, it is difficult to obtain the sufficient effects unless the molar fraction of the lithium fluoroalkyl phosphate occupying in the whole electrolyte salt exceeds 0.5.

While the present application has been described with reference to the embodiments and working examples, it should not be construed that the present application is limited to the foregoing embodiments and working examples, but various modifications can be made. For example, while the secondary battery having a wound structure has been described in the foregoing embodiments and working examples, the present application is similarly applicable to secondary batteries having a structure in which a positive electrode and a negative electrode are folded or stacked. In addition, the present application is also applicable to secondary batteries of a so-called coin type, button type, rectangular type or laminated film type or the like.

Also, in the foregoing embodiments and working examples, while the case of using a nonaqueous electrolytic solution has been described, the present invention is also applicable to the case of using a nonaqueous electrolyte in any form. Examples of the nonaqueous electrolyte in other form include a nonaqueous electrolyte in a so-called gel state in which a nonaqueous solvent and an electrolyte salt are held in a polymer compound.

Furthermore, in the foregoing embodiments and working examples, while a so-called lithium ion secondary battery in which the capacity of a negative electrode is expressed by a capacity component due to intercalation and deintercalation of lithium has been described, the present invention is also applicable to a so-called lithium metal secondary battery in which a lithium metal is used for a negative electrode active material, and the capacity of the negative electrode is expressed by a capacity component due to deposition and dissolution of lithium; or a secondary battery in which by making the charge capacity of a negative electrode material capable of intercalating and deintercalating lithium smaller than the charge capacity of a positive electrode, the capacity of a negative electrode includes a capacity component due to intercalation and deintercalation of lithium and a capacity component due to deposition and dissolution of lithium and is expressed by the total sum thereof.

Also, in the foregoing embodiments and working examples, while a battery using lithium as an electrode reactant has been described, the present invention is also applicable to the case of using other alkali metal such as sodium (Na) and potassium (K), an alkaline earth metal such as magnesium and calcium (Ca), or other light metal such as aluminum.

It should be understood that various changes and modifications to the presently preferred embodiments described herein will be apparent to those skilled in the art. Such changes and modifications can be made without departing from the spirit and scope and without diminishing its intended advantages. It is therefore intended that such changes and modifications be covered by the appended claims.

The application is claimed as follows:

1. A nonaqueous electrolyte secondary battery comprising:
a positive electrode;
a negative electrode;
a nonaqueous electrolyte containing an electrolyte salt; and
a separator, wherein
in the electrolyte salt, a molar fraction x of at least one member selected among electrolyte salts represented by the following formulae (1) and (2) occupying in the whole electrolyte salt satisfies a relationship of (0.5<x≦1)
LiPFaAc (1)
LiBFbB′d (2)
wherein
a represents an integer of from 0 to 5; b represents an integer of from 0 to 3; each of A and B′ independently represents CₙF₂ₙ₊₁; n represents an integer of from 1 to 6; c represents an integer of 1 or more and satisfies a relationship of (a+c=6); and d represents a an integer of 1 or more and satisfies a relationship of (b+d=4).

2. The battery according to claim 1, wherein
the electrolyte salt contains at least one compound selected from electrolyte salts including a chain imide salt represented by the following formula (3) and a cyclic imide salt represented by the following formula (4):
LiN(CₑF₂ₑ₊₁SO₂)_{g}(C_{f}F_{2f+1}SO₂)_{2-g} (3)
Formula (4) 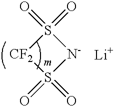
wherein
each of e and f independently represents an integer of from 0 to 6; g represents an integer of from 0 to 2; and m is 2 or 3.

3. The battery according to claim 1, wherein
a total content of the whole electrolyte salt in the nonaqueous electrolyte is from 0.1 to 3.0 moles/kg.

4. The battery according to claim 1, wherein
the nonaqueous electrolyte contains from 0.01 to 10% by mass of a cyano group-containing compound.

5. The battery according to claim 1, wherein
the nonaqueous electrolyte contains from 0.01 to 30% by mass of a halogen atom-containing cyclic carbonate derivative.

6. The battery according to claim 5, wherein
the carbonate derivative is 4-fluoro-1,3-dioxolan-2-one and/or 4,5-difluoro-1,3-dioxolan-2-one.

7. The battery according to claim 1, wherein
an open circuit voltage in a completely charged state per pair of the positive electrode and the negative electrode is from 4.25 to 6.00 V.

8. A nonaqueous electrolyte in which at least one member of the electrolyte salts represented by the formulae (1) and (2) according to claim 1 has a molar fraction x occupying in the whole electrolyte salt satisfies a relationship of (0.5<x≦1).
